(19) United States
(12) Patent Application Publication
(10) Pub. No.: US 2014/0342810 A1
(43) Pub. Date: Nov. 20, 2014

(54) Electronic coin-operated merchandiser with remote management system

(71) Applicant: Douglas Duba, Cicero, IL (US)

(72) Inventor: Douglas Duba, Cicero, IL (US)

(21) Appl. No.: 13/896,940

(22) Filed: May 17, 2013

(51) Int. Cl. G07F 17/32

(52) U.S. Cl. CPC G07F 17/3246
USPC 463/25

(57) ABSTRACT

Electronic coin-operated merchandiser utilizing a touch screen, large panel display, local processor, and camera which is managed by a remote management system. The large flat display is used to present the games and videos of available prizes in an attract mode. Images of winning players are captured, uploaded to the remote management system, processed, and then downloaded to potentially all devices on the network where they are utilized in an attract mode to entice potential players. The device does not require prizes to be distributed locally; instead, the remote management system tracks wins and allows operators to ship prizes to winning players from a remote fulfillment centers. By managing games and prizes from a remote management system, the devices can be quickly and easily updated or changed with respect to the games and prizes being offered, which makes the investment in the merchandiser more desirable to the machine operator.

### FEDERALLY SPONSORED RESEARCH

Not Applicable

### SEQUENCE LISTING OR PROGRAM

### Not Applicable

### CROSS REFERENCE TO RELATED APPLICATIONS

### Not Applicable

### TECHNICAL FIELD OF THE INVENTION

The present invention relates generally to an electronic coin-operated merchandiser. More specifically, the present invention relates to an electronic coin-operated merchandiser that has a cabinet, a touchscreen, a local processor and a remote management system.

### BACKGROUND OF THE INVENTION

A number of different devices are currently in use within the coin-operated amusement industry. These devices allow players an opportunity to win prizes which are vended locally from the merchandiser by playing a game of skill. Merchandisers are typically placed in a variety of locations where the operator of the device is not on site including: bars, laundromats, restaurants, truck stops, and the vestibule area of stores. Operators of coin-operated merchandisers desire to maximize the earnings of individual devices, which is generally accomplished by effectively showcasing prizes to attract players, providing engaging skill based games and minimizing the labor incurred for visits to locations to maintain the devices.

### SUMMARY OF THE INVENTION

The present invention is an electronic coin-operated merchandiser with touchscreen, local processor, and remote management system. The device is monitored, managed and updated from a remote management system. By administering the merchandiser from its remote management system, games can be added and subtracted, the difficulty of specific games can be tuned for optimal payout percentages, prizes can be added and subtracted, prize awards can be remotely fulfilled, critical financial data can be tracked, and device statistics can be monitored providing operators critical data which can be utilized to maximize the earnings of the device.

The remote management system monitors and compiles all device activity including monies inserted, games played, prizes selected for potential award, time on device and the outcome of games played. This data is available to the operator through a single internet portal accessible from anywhere in the world. Operators may utilize the collective data to identify and then cull the least desirable games and prizes and adjust the difficulty of certain games in order to maximize the earnings of the device. These adjustments can be made globally to a multitude of devices attached to the remote management system allowing the operator to quickly and easily adjust the devices to maximize earnings.

The device and method of the present invention does not require prizes to be distributed locally; instead, the remote management system tracks wins and allows the operator to ship prizes to winning players from a remote distribution center. As merchandisers are typically placed in locations where the operators are not on site including: bars, laundromats, restaurants, truck stops, and the vestibule area of stores, the labor incurred in loading prizes is greatly reduced.

The merchandiser is comprised of a large flat display screen which is not only used to display the game, but also to display the prizes. In order to entice potential players, polished Hollywood style videos of the prizes are displayed on the large flat panel display. The remote management system allows operators to remotely update prize selections.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the external components, features, and elements of the merchandiser of the present invention;

FIG. 2 illustrates the high level logic diagram of the merchandiser and the local processor of the present invention;

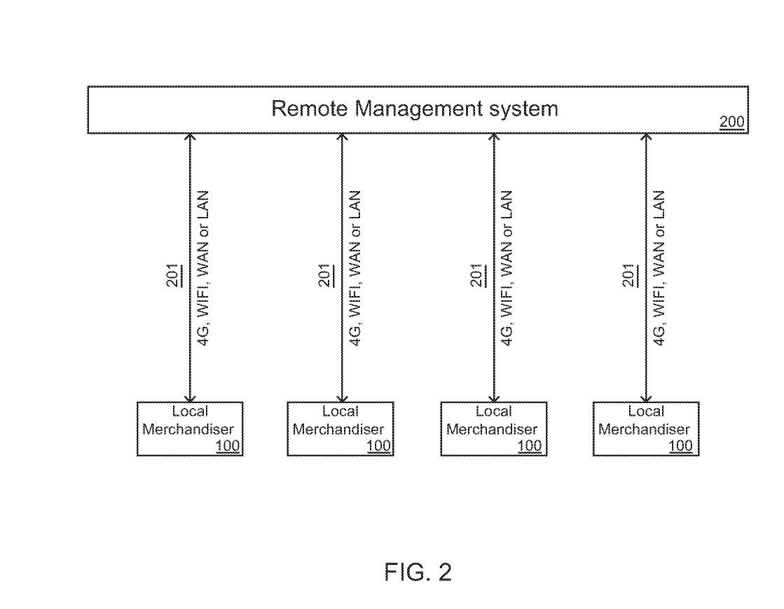

FIG. 3 illustrates the method for capturing images of winning players and processing them for later display in merchandiser; and

FIG. 4 illustrates the control dashboard for remote management system of the merchandiser.

### DETAILED DESCRIPTION OF THE INVENTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, an embodiment of the present invention is shown. The present invention is an electronic merchandiser 100 with large flat display screen 101, touch screen 102, and local processor 106. The merchandiser 100 is intended to be placed in bars, laundromats, restaurants, truck stops, and store vestibules and to offer skill based games to players. This device is managed from a remote central system. Winning players are asked to enter their names and addresses allowing prizes to be shipped from a remote fulfillment center; or alternatively, in another embodiment, a ticket is printed providing instruction on how to collect an award.

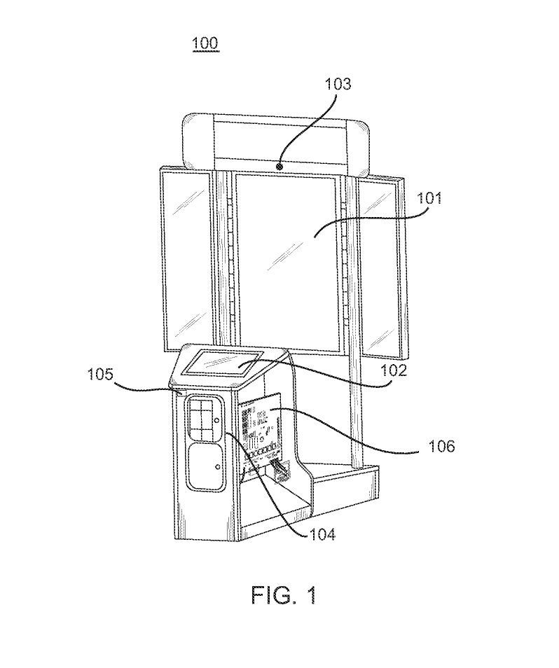

Now referring to FIG. 1, the merchandiser 100 is comprised of a large flat display screen 101 which is not only used to display the game, but also presents videos of the prizes that can be potentially won by playing offered games. The touch screen display 102 of the merchandiser 100 is the controller and input means for use by players for participating in the games, selecting prizes, and otherwise interacting with the merchandiser. A webcam 103 or other image capturing device is included in the merchandiser 100 for allowing the operator to capture images of winning players to be uploaded to the remote management system. A local processor 106 is provided to run the merchandiser 100 and interface with display screen 101, touch screen 102, and webcam 103 as well as provide communication to the remote management systems via the internet utilizing various methods including: 4G, WIFI, WAN, or LAN 200. The merchandiser 100 is also comprised of industry standard features, such as a credit card reader, dollar bill acceptor, and coin acceptor 104. Finally, a printer 105 is also included for distributing tickets which will instruct winning players how to collect winning prizes.

Highly polished Hollywood style commercials showcase a small selection of high end prizes. In some embodiments, prizes are displayed or available for distribution directly from the device. By managing the merchandiser from its remote management system, games can be added and subtracted, available prizes can be added and subtracted, prize distribution can be remotely fulfilled and device statistics can be monitored, providing operators critical data which can be utilized to maximize the earnings of the device. Additionally, the game can be adjusted and controlled with respect to skill levels based on its location and the desired payout percentage.

For example, such a game may be placed in a large restaurant establishment for young adults that may have a higher skill level than one placed in a restaurant and game location for children. In this instance, the merchandiser 100 can be remotely updated; not only to offer targeted games and prizes, but to also adjust the skill levels needed to obtain a win. The invention now allows operators to offers a dynamic selection of games and prizes which is a significant advantage over the static offerings of previous merchandisers.

An attract mode is displayed on the large display screen 101 in order to attract the attention of potential players. The local processor 106 and remote management system 200 control what is displayed for attraction purposes and can be remotely changed, updated, or targeted to the audience based on date or time, location type, specific demographics, and the geographical location.

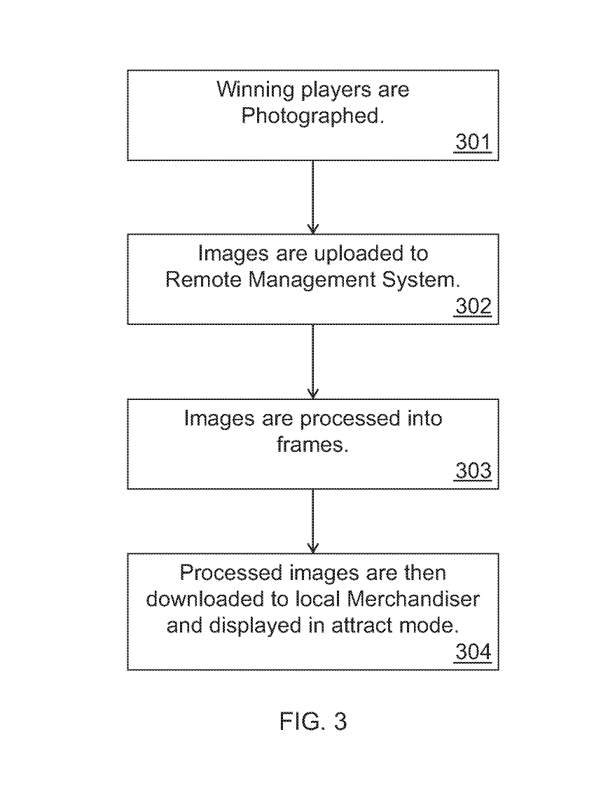

A webcam 103 or other image capturing device is included in the merchandiser 100 for allowing the device to capture images of winning players and upload to the remote management system. These images are then processed by the remote management system 200 and touched up visually as necessary and distributed back to the merchandiser 100 and/or to other devices on the network as desired. When the image is returned to the local merchandiser 100, other potential players can see the images of the winning players on the large display screen 101. Displaying images of winning players entices additional players to play the device. Now referring to FIG. 3, the method of processing participant images is provided. Winning players are photographed 301 using the webcam 103 and images captured. The images are uploaded 302 to the remote management system 200. The images are processed into frames 303. The processed images are then downloaded to local devices and used in attract mode displays 304.

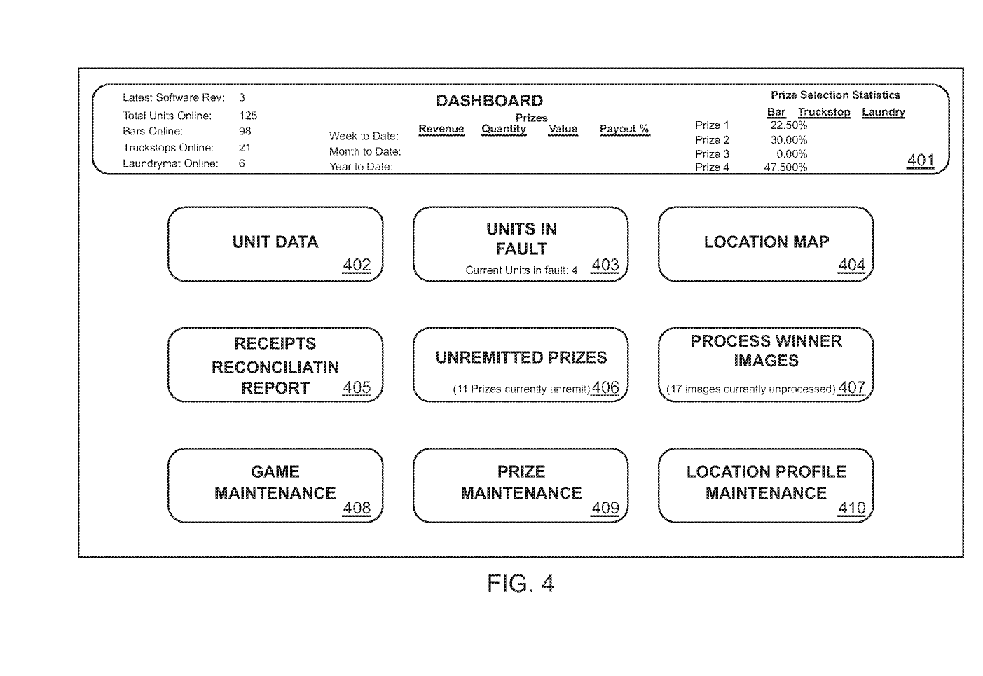

Now referring to FIG. 4, a simulated screen shot of the remote management system dashboard 400 for managing the merchandiser 100 is shown. The dashboard 400 is broken down into ten sub-windows.

Window 401 provides summary data for all units connected to the remote management system. This information includes the total number of units online, aggregate revenue and prize expense and a breakdown of prizes selected by location type. In the prize window 401, a manager can quickly identify unit status by seeing how many units or individual merchandisers are online and communicating with the remote management system 200 and the categorical location types such as being located in a bar, truck stop, or laundromat. Critical accounting statistics are located in the center of the prize window 401 and track weekly, monthly, and yearly prize revenue, quantities and values of prizes, and payout percentages. Prize selection statistics are also displayed in the prize window 401 and track prize type with selection statistics based on locations so that a manger can target prizes to the audience location that finds a specific prize desirable and attractive resulting in maximum game plays.

Operators can view all historical data for a specific unit in the network by selecting window 402, unit data. Units in fault are immediately identified in Window 403 and the location of all units in the network can be viewed by selecting locations map 404.

Accounting records and financial internal controls including the ability to tie cash receipts to bank deposits are available by selecting receipts reconciliation report 405.

Unremitted prizes 406 and process winner images 407 provide the operator with a listing of prizes won but not yet shipped to customers and images of winning players for later processing.

Game Maintenance 408 and prize maintenance 409 allow the operator to add, remove and modify games and prizes globally for all devices on the network. Location profile maintenance 410 allows the operator to add and subtract a type of location for which they wish to track data and to define the game offerings and prize offering for this type of location.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. An electronic coin-operated merchandiser device, comprising in combination:
a display screen;
a local processor;
one or more games;
a payment processor including: a bill acceptor, coin acceptor, or credit card reader; and
wherein the display presents videos of the prizes that can be obtained by winning the games offered.

2. The device of claim 1, further comprising
a touch screen; and
wherein the touch screen is the controller and input means for use by players for participating in the games, selecting prizes, and interacting with the merchandiser.

3. The device of claim 2, wherein player data is collected via a touchscreen simulated keyboard.

4. The device of claim 1, further comprising a remote management system.

5. The device of claim 4, wherein the games are added, subtracted, updated and managed from a remote management system.

6. The device of claim 4, wherein the games can be adjusted and controlled with respect to skill level based on the device's location and desired payout percentage by the remote management system.

7. The device of claim 4, wherein player preferences are tracked by the remote management system.

8. The device of claim 4, wherein the prize videos can be added and subtracted by the remote management system.

9. The device of claim 1, wherein
the names and addresses of winning players are entered into the device for distribution of prizes from a remote distribution center, or
a ticket is printed for the winning player providing instructions on how to redeem prizes.

10. The device of claim 1, further comprising
a camera; and
images of winning players are captured by the camera.

11. The device of claim 4, further comprising
a camera;
images of winning players are captured by the camera; and
the captured images of winning players are uploaded to the remote management system.

12. The device of claim 11, wherein
the captured images are processed and touched up visually as necessary by the remote management system; and
the captured images of winning players are processed and distributed to potentially all devices in the network and displayed in an attract mode by the remote management system.

13. The device of claim 4, wherein
the remote management system monitors aggregate statistical data of all devices on the network; and
the remote management system summarizes the aggregate statistical data in a dashboard.

14. The device of claim 4, wherein the remote management system summarizes:
a number of devices online and communicating with the remote management system;
game revenue, quantities and values of prizes awarded, and payout percentages for the devices; and
the categorical breakdown prizes selected by location type.

15. The device of claim 4, wherein a remote management system:
provides historical data for specific units in the network;
flags units in fault and provides details on the locations of the device and error;
generates a location map of all units in the network;
provides accounting data;
provides a list of all unremitted prizes;
collects images of winning player;
globally adds, removes, and modifies games available on all devices in the network;
globally adds and removes prizes available on all devices in a network; and
allows for definitions of location profiles and provides configurations of game offerings and prize offering for all devices on the network by location profile.
